(19) United States
(12) Patent Application Publication
(10) Pub. No.: US 2012/0082019 A1
(43) Pub. Date: Apr. 5, 2012

(54) INFORMATION RECORDING DEVICE, INFORMATION RECORDING METHOD, AND ELECTRONIC APPARATUS

(75) Inventor: Akihiro HARIGAE, Ome-shi (JP)

(73) Assignee: KABUSHIKI KAISHA TOSHIBA, Tokyo (JP)

(21) Appl. No.: 13/245,618

(22) Filed: Sep. 26, 2011

(30) Foreign Application Priority Data
Sep. 30, 2010 (JP) 2010-223218

(51) Int. Cl. G11B 20/18

(52) U.S. Cl. 369/53.41; G9B/20.046

(57) ABSTRACT

An information recording device includes: a magnetic disk; an identify module; and a record module. The magnetic disk includes information tracks for recording information by a shingle recording method and an alternate track including an alternate sector for recording alternate information. The identify module is configured to identify a track group including the information tracks that includes update sectors for updating information and a defective sector. The record module is configured to perform recording for updating information on the identified track group without updating the alternate information of the alternate sector corresponding to the defective sector.

### CROSS REFERENCE TO RELATED APPLICATION(S)

The present disclosure relates to the subject matters contained in Japanese Patent Application No. 2010-223218 filed on Sep. 30, 2010, which are incorporated herein by reference in its entirety.

### FIELD

An embodiment described herein generally relates to an information recording device which records information on a storage medium, an information recording method, and an electronic apparatus.

### BACKGROUND

In recent years, various techniques are developed to increase the recording capacity of magnetic recording devices. Among these techniques, there is a recording technique called “shingle recording method.” The shingle recording method is a recording method in which recording is performed with adjacent ones of the recording tracks of a magnetic disk overlapped with each other (partial group including plural adjacent tracks is defined as a recording unit. Even when only a track among the track group is to be rewrote, rewriting the track alone is not possible and the entire track group is rewrote.

Defects may occur on a recording surface of a magnetic disk. Defects are detected in a manufacturing process of a magnetic disk device or in an ordinary use state and pieces of position information enabling identification of the detected defects are recorded. Defects may occur locally or in a certain range, and are generally recorded by the sector. The sector is defined on a magnetic disk. Information to be recorded in a defective sector is recorded in an alternate sector instead. The alternate sector is a sector not recorded as a defective one. This processing is called alternate processing, and many techniques for performing alternate processing efficiently are disclosed. Defective sector alternate processing is also performed in magnetic disk devices that employ the shingle recording method.

However, where information is recorded in alternate sectors by the shingle recording method, information that is recorded in a track group including a defective sector cannot be updated efficiently. For example, in updating information recorded in a track group including a defective sector, information is recorded on both of the track group including the defective sector and a track group including an alternate sector. That is, information update processing on an alternate sector in which information is recorded by the shingle recording method cannot be performed efficiently.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is an exemplary block diagram showing the configuration of an electronic apparatus including a magnetic disk device (HDD) as an information recording device according to an embodiment.

FIG. 2 is an exemplary flowchart of an information update process which is performed by the HDD according to the embodiment.

FIG. 3 shows a specific example of update processing performed by the HDD according to the embodiment.

### DETAILED DESCRIPTION OF THE EMBODIMENTS

According to one embodiment, an information recording device includes: a magnetic disk; an identify module; and a record module. The magnetic disk includes information tracks for recording information by a shingle recording method and an alternate track including an alternate sector for recording alternate information. The identify module is configured to identify a track group including the information tracks that includes update sectors for updating information and a defective sector. The record module is configured to perform recording for updating information on the identified track group without updating the alternate information of the alternate sector corresponding to the defective sector.

An embodiment will be hereinafter described with reference to the drawings.

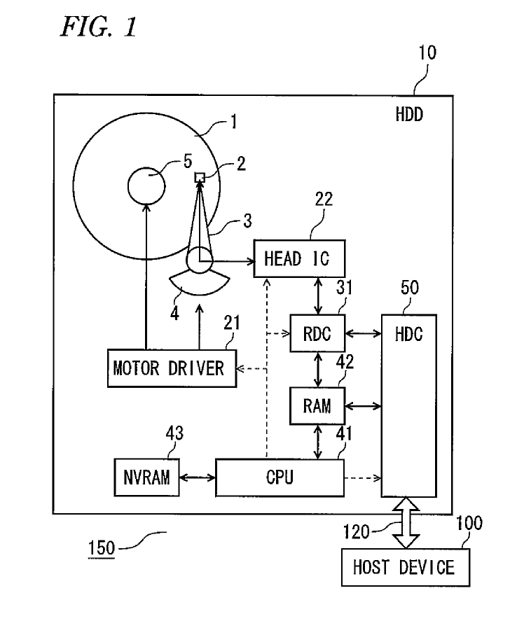

FIG. 1 is an exemplary block diagram showing the configuration of an electronic apparatus 150 which is equipped with a magnetic disk device (hereinafter also referred to as HDD) 10 as an information recording device according to the embodiment. The electronic apparatus 150 is also equipped with a host device 100. The HDD 10 is connected to the host device 100 via a communication medium (host I/F) 120 and functions as a storage module of the host device 100. The host I/F 120 connects the host device 100 and the HDD 10 and is used for exchanging data and commands between the host device 100 and the HDD 10. For example, the electronic apparatus 150 is a personal computer and the host device 100 is a central processing unit (CPU) of the personal computer.

The HDD 10 according to the embodiment includes mechanism components such as a magnetic disk 1, a slider 2, an arm 3, a voice coil motor (VCM) 4, and a spindle motor (SPM) 5. The HDD 10 also includes circuit blocks such as a motor driver 21, a head IC 22, a read/write channel IC (hereinafter also referred to as RDC) 31, a CPU 41, a RAM 42, an NVRAM 43, and a hard disk controller (HDC) 50.

In the HDD 10 according to the embodiment, information is recorded on the magnetic disk 1 by a write head (not shown) which is provided on the slider 2. The HDD 10 performs alternate processing of recording, in a non-defective sector as an alternate for a defective sector, information to be recorded in the defective sector on the recording surface of the magnetic disk 1. To record information on the recording surface of the magnetic disk 1, the recording technique called “shingle recording method” is used. The shingle recording method is a recording method in which recording is performed with adjacent ones of the recording tracks defined on the magnetic disk 1 overlapped with each other (partial overwriting). In the shingle recording method, a track group including plural adjacent tracks is defined as a recording unit. Even when only a track among the track group is to be rewrote, rewriting the track alone is not possible and the entire track group is rewrote. The HDD according to the embodiment efficiently performs processing of updating the information recorded in alternate sectors employing the shingle recording method.

Fixed to the SPM 5, the magnetic disk 1 is rotated being driven by the SPM 5. At least one surface of the magnetic disk 1 is a recording surface on which information is recorded magnetically. Tracks are defined on the recording surface and sectors are defined on each track. Address information is assigned to each sector.

The slider 2 is provided at one end of the arm 3 so as to be opposed to the recording surface of the magnetic disk 1. The slider 2 is provided with a read head and a write head (neither of which is shown). The read head reads a signal that is magnetically recorded on the recording surface of the magnetic disk 1. The read-out signal is output to the head IC 22 via conductor patterns formed on the arm 3. The write head magnetically records, on the recording surface of the magnetic disk 1, a write signal (write current) that is input from the head IC 22 via conductor patterns formed on the arm 3.

The arm 3 is provided with the slider 2 at one end and with a bearing portion (not shown) at the other end. The arm 3 is rotated with the bearing portion as a rotation center according to a drive current that is supplied to the VCM 4, and thereby moves the slider 2 in the radial direction over the recording surface of the magnetic disk 1.

The VCM 4 is driven according to a drive signal (current) that is supplied from the motor driver 21, and thereby rotates the arm 3.

The SPM 5 is driven according to a drive signal (current) that is supplied from the motor driver 21, and thereby rotates the magnetic disk 1.

The motor driver 21 supplies the VCM 4 with a drive signal (current) for driving it and supplies the SPM 5 with a drive signal (current) for driving it under the control of the CPU 41.

The head IC 22 amplifies a signal that is input from the read head of the slider 2 via the conductor patterns formed on the arm 3, and outputs an amplified signal to the RDC 31 as read information. Furthermore, the head IC 22 outputs a write signal (write current) corresponding to recording information that is input from the RDC 31, to the write head of the slider 2 via the conductor patterns formed on the arm 3.

The RDC 31 decodes read information that is input from the head IC 22 by performing certain processing on it, and outputs resulting decoded information to the HDC 50. Furthermore, the RDC 31 encodes recording subject information that is input from the HDC 50 by performing certain processing on it, and outputs resulting coded information to the head IC 22 as recording information. The RDC 31 extracts address information relating to a sector that is defined for a track from read information, and outputs the extracted address information to the CPU 41. The RDC 31 uses the RAM 42 as a work memory in performing the certain processing for encoding or decoding.

The CPU 41 controls the individual blocks of the HDD 10 according to programs stored in the NVRAM 43. The CPU 41 is a processor for controlling operations of rotating the VCM 4 and the SPM 5 and recording of information on the magnetic disk 1. The CPU 41 uses the RAM 42 as a work memory in running the programs.

In the embodiment, the CPU 41 identifies a sector physical address based on address information that is input from the RDC 31. The sector physical address is physical address information that is assigned to each sector which is defined for a track of the magnetic disk 1. The CPU 41 records information on the magnetic disk 1 by the shingle recording method, and performs alternate processing of recording information in an alternate sector instead of a defective sector. The CPU 41 is informed of a logical address from which to start information recording through a write command that is communicated via the HDC 50. The CPU 41 also performs logical-to-physical conversion processing of converting a logical address that is input from the RDC 31 into a physical address that is defined on the magnetic disk 1.

The RAM 42 is a work memory for the RDC 31, the CPU 41, and the HDC 50. The RAM 42 is a DRAM which is a volatile memory.

The NVRAM 43 is a nonvolatile memory for storing programs to be run by the CPU 41. The programs stored in the NVRAM 43 can be updated.

The HDC 50 performs communication processing of transmitting and receiving information to and from the host device 100. The HDC 50 encodes decoded information that is input from the RDC 31 by performing certain processing on it, and transmits resulting coded information to the host device 100 as transmission information. The HDC 50 decodes reception information received from the host device 100 by performing certain processing on it, and outputs resulting decoded information to the RDC 31 as recording subject information. For example, the HDC 50 performs communication processing that complies with the serial advanced technology attachment (SATA) standard to communicate with the host device 100. When receiving, from the host device 100, a write command containing information of a logical address from which to start data recording and recording data length information, the HDC 50 extracts the logical address and the recording data length from the received write command and outputs the extracted logical address information and recording data length information to the CPU 41.

In the above-configured HDD 10 according to the embodiment, information is recorded on the magnetic disk 1 by the plural blocks of the HDD 10 by the shingle recording method. A logical address that is communicated from the host device 100 is converted into a physical address indicating a sector that is defined on the magnetic disk 1. Alternate processing and update processing are performed based on address information that has been subjected to logical-to-physical conversion processing. In the embodiment, update processing on a track group including a defective sector is performed efficiently after performing of alternate processing from the defective sector to an alternate sector. That is, the HDD 10 according to the embodiment is able to more efficiently perform information update processing on an alternate sector in which information is recorded by the shingle recording method.

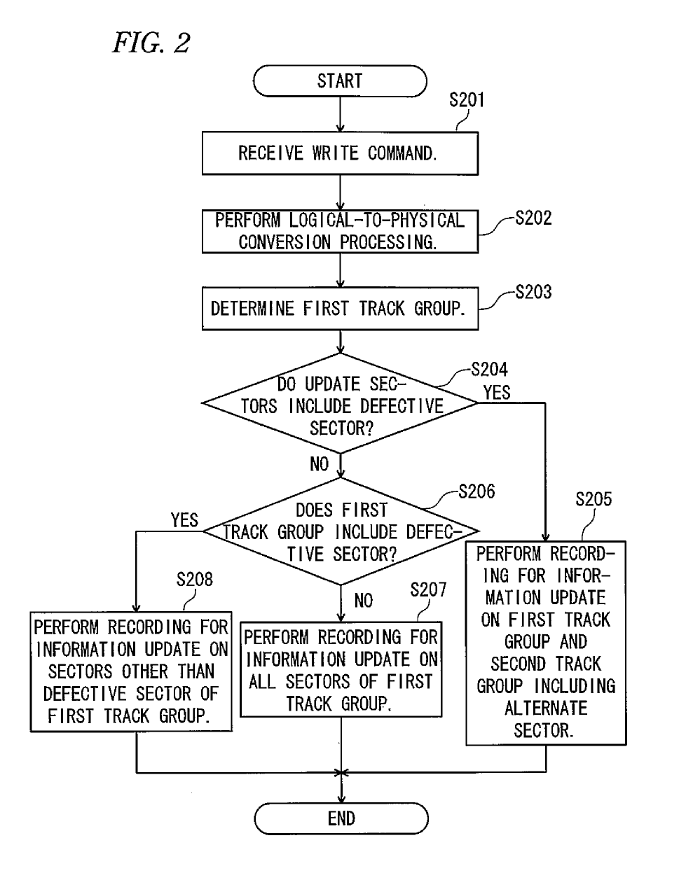

Next, an information update process which is performed by the HDD 10 according to the embodiment will be described with reference to FIG. 2. FIG. 2 is an exemplary flowchart of the information update process which is performed by the HDD 10 according to the embodiment.

First, at step S201, the HDC 50 receives a write command from the host device 100. The HDC 50 extracts, from the received write command, a logical address from which to start data recording and recording data length. The extracted logical address information is output to the CPU 41. At step S202, the CPU 41 converts the received logical address to a physical address. At step S203, the CPU 41 determines a first track group including update sectors corresponding to update information based on the resulting physical address (from which to start data recording) and the recording data length information received from the HDC 50.

At step S204, the CPU 41 determines whether or not the update sectors include a defective sector. If determining that the update sectors include a defective sector (S204: yes), at step S205 the CPU 41 performs recording for information update on the first track group and a second track group including an alternate sector for the thus-detected defective sector. If determining that the update sectors do not include a defective sector (S204: no), at step S206 the CPU 41 determines whether or not the first track group includes a defective sector. If the first track group does not include a defective sector (S206: no), at step S207 the CPU 41 performs recording for information update on all the sectors of the first track group. If the first track group includes a defective sector (S206: yes), at step S208 the CPU 41 performs recording for information update on sectors other than the defective sector of the first track group.

As described above, information update for a first track group that is determined based on a physical address corresponding to a logical address that is specified by a write command is performed depending on whether the first track group includes a defective sector. In particular, when update sectors include no defective sector and the first track group includes a defective sector that is not located in the update sectors, a second track group is not subjected to information update. That is, the HDD 10 according to the embodiment is able to more efficiently perform information update processing on an alternate sector in which information is recorded by the shingle recording method.

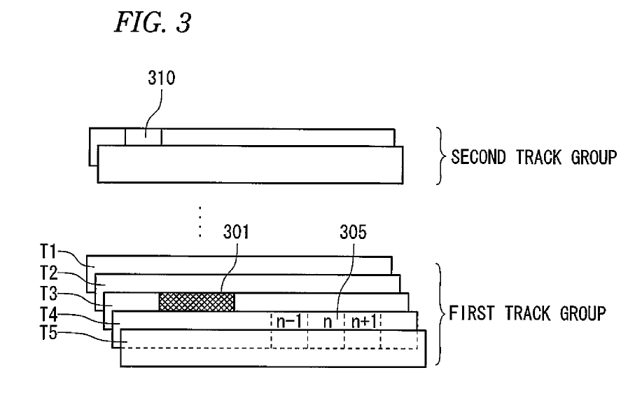

Next, a specific example of update processing performed by the HDD 10 according to the embodiment will be described with reference to FIG. 3. FIG. 3 shows a specific example of update processing performed by the HDD 10 according to the embodiment.

In the specific example of FIG. 3, a first track group includes five tracks T1-T5. In this specific example, the first track group includes update sectors 301 and also includes a defective sector 305 that is not located in the update sectors 301. The update sectors 301 are located on the track 13 and the defective sector 305 is an nth sector of the track T4. An alternate sector 310 for the defective sector 305 is located in a second track group.

In this specific example, data recording sectors that are identified by a write command that is transmitted from the host device 100 are the update sectors 301. Furthermore, the update sectors 301 includes no defective sector including the defective sector 305 and the first track group (tracks T1-T5) includes the defective sector 305 that is not located in the update sectors 301. Therefore, the CPU 41 does not perform information update on the second track group. The CPU 41 performs information update on the first track group in the following manner. The CPU 41 records information on the track 11 to the track T3 which includes the update sectors 301 and then continues the recording to the (n−1)th sector of the track 14. Then, the CPU 41 does not record information in the nth sector (defective sector 305) of the track T4 and restarts recording from the (n+1)th sector of the track T4. After recording information in the last sector of the track T4, the CPU 41 starts recording on the track 15. The CPU 41 does not record information in the alternate sector 310 of the second track group.

As such, the HDD 10 according to the embodiment is able to more efficiently perform information update processing on an alternate sector in which information is recorded by the shingle recording method.

As described above, in the embodiment, information is recorded on the magnetic disk 1 by the shingle recording method. Alternate processing and update processing are performed based on a physical address obtained by converting a logical address that is specified by a write command that is communicated from the host device 100. When update processing on a track group including a defective sector is performed after alternate processing from the defective sector to an alternate sector, update processing is not performed on a track group including the alternate sector. Since an unnecessary seek operation is not performed in information update processing, performance degradation of the update processing is able to be avoided. As a result, the HDD 10 according to the embodiment is able to more efficiently perform information update processing on an alternate sector in which information is recorded by the shingle recording method.

The invention is not limited to the above embodiment and various changes, modifications, etc. are possible without departing from the spirit and scope of the invention. And various inventions can be conceived by properly combining plural constituent elements disclosed in the embodiment. For example, several ones of the constituent elements of the embodiment may be omitted.

What is claimed is:

1. An information recording device comprising:
a magnetic disk comprising information tracks for recording information by a shingle recording method and an alternate track comprising an alternate sector for recording alternate information;
an identifying module configured to identify a track group comprising a subset of the information tracks that comprise update sectors for updating information and a defective sector; and
a recording module configured to update information on the identified track group without updating the alternate information of the alternate sector corresponding to the defective sector.

2. The information recording device of claim 1, wherein the recording module is further configured to update information on the identified track group without updating the alternate information of the alternate sector corresponding to the defective sector when the defective sector is associated with sectors other than the update sectors in the identified track group.

3. The information recording device of claim 1, wherein the recording module is further configured to update information on sectors other than the defective sector in the identified track group when the defective sector is not one of the update sectors.

4. The information recording device of claim 2, wherein the recording module is further configured to update information on sectors other than the defective sector in the identified track group when the defective sector is not one of the update sectors.

5. The information recording device of claim 1, wherein the alternate track is configured to record the alternate information by the shingle recording method.

6. The information recording device of claim 2, wherein the alternate track is configured to record the alternate information by the shingle recording method.

7. The information recording device of claim 3, wherein the alternate track is configured to record the alternate information by the shingle recording method.

8. An information recording method performed by an information recording device comprising a magnetic disk comprising information tracks for recording information by a shingle recording method and an alternate track comprising an alternate sector for recording alternate information, the information recording method comprising:
identifying a track group comprising a subset of the information tracks that comprise update sectors for updating information and a defective sector; and
updating information on the identified track group without updating the alternate information of the alternate sector corresponding to the defective sector.

9. The information recording method of claim 8, further comprising updating information on the identified track group without updating the alternate information of the alternate sector corresponding to the defective sector when the defective sector is associated with sectors other than the update sectors in the identified track group.

10. The information recording method of claim 8, further comprising updating information on sectors other than the defective sector in the identified track group when the defective sector is not one of the update sectors.

11. The information recording method of claim 9, further comprising updating information on sectors other than the defective sector in the identified track group when the defective sector is not one of the update sectors.

12. The information recording method of claim 8, wherein the alternate track is configured to record the alternate information by the shingle recording method.

13. The information recording method of claim 9, wherein the alternate track is configured to record the alternate information by the shingle recording method.

14. The information recording method of claim 10, wherein the alternate track is configured to record the alternate information by the shingle recording method.

15. An electronic apparatus comprising:
a host device;
a magnetic disk comprising information tracks for recording information by a shingle recording method and an alternate track comprising an alternate sector for recording alternate information, wherein the information is transmitted from the host device;
an identifying module configured to identify a track group comprising a subset of the information tracks that comprise update sectors for updating information and a defective sector; and
a recording module configured to update information on the identified track group without updating the alternate information of the alternate sector corresponding to the defective sector.

16. The electronic apparatus of claim 15, wherein the recording module is further configured to update information on the identified track group without updating the alternate information of the alternate sector corresponding to the defective sector when the defective sector is associated with sectors other than the update sectors in the identified track group.

17. The electronic apparatus of claim 15, wherein the recording module is further configured to update information on sectors other than the defective sector in the identified track group when the defective sector is not one of the update sectors.

18. The electronic apparatus of claim 16, wherein the recording module is further configured to update information on sectors other than the defective sector in the identified track group when the defective sector is not one of the update sectors.

19. The electronic apparatus of claim 15, wherein the alternate track is configured to record the alternate information by the shingle recording method.

20. The electronic apparatus of claim 16, wherein the alternate track is configured to record the alternate information by the shingle recording method.
